(19) United States
(12) Patent Application Publication
(10) Pub. No.: US 2019/0362435 A1
(43) Pub. Date: Nov. 28, 2019

(54) TRAVEL PURPOSE DETERMINATION METHOD, TRAVEL PURPOSE DETERMINATION APPARATUS, AND TRAVEL PURPOSE DETERMINATION SYSTEM

(71) Applicant: HITACHI, LTD., Tokyo (JP)

(72) Inventors: Youko HIRASHIMA, Tokyo (JP); Kojin YANO, Tokyo (JP); Masashi IMAMURA, Tokyo (JP)

(73) Assignee: HITACHI, LTD., Tokyo (JP)

(21) Appl. No.: 16/419,728

(22) Filed: May 22, 2019

(30) Foreign Application Priority Data
May 22, 2018 (JP) 2018-097792

(51) Int. Cl. G06Q 40/00; G06N 5/02; G06Q 10/10

(52) U.S. Cl. CPC G06Q 40/12; G06Q 10/1093; G06N 5/027

(57) ABSTRACT

Travel purpose determination according to the present disclosure, is provided with: a determination rule specifying date and time for allowing use of a transport system for business, a geographical area, and a destination; and a usage history acquisition unit that acquires an entry station, an exit station, usage date and time included in usage record of the transport system, user identification information, and location information. The travel purpose determination includes determining whether a purpose of travel is usage on business, based on acquired information and the determination rule.

### BACKGROUND OF THE INVENTION

### 1. Field of the Invention

The present invention relates to a travel purpose determination method, a travel purpose determination apparatus, and a travel purpose determination system, for determination of a purpose of travel from travel history.

### 2. Description of the Related Art

The style of commuting has been changing in accordance with the diversification of choices in forms of employment. It is considered that the spread of telework and office sharing will reduce commuters who commute to the same places daily, in the future. In that case, companies will review allowances for “commutation passes” premised on commuting to the same places daily. Commutation passes allow users to use only fixed specific means of transport, and thus commutation passes are unsuitable for the reality of travel.

Meanwhile, one-stop service called Mobility as a Service (MaaS) enabling searching, reserving, and payment for various means of transport, such as railways, buses, and taxies, has been spreading. For MaaS, a package combining a plurality of means of transport or a gradual charging system responsive to a usage level has been examined.

Note that, in order to practically use service such as MaaS, companies need to distinguish travel necessary on business and the rest travel from the daily travel of employees that is not fixed for destinations and means of transport.

For the need, Japanese Patent Application No. 2016-81101 describes “on the basis of: a transport expense application including a date, an expenditure, an entry station, and an exit station acquired from a storage medium enabling payment for a railway fare; and candidate routes and fares acquired on search conditions including the entry station as a departure station, the exit station as an arrival station, and the date, approval or disapproval of the transport expense application is determined in accordance with whether the expenditure agrees with at least one of the candidates”.

JP 2014-49076 A describes “previously setting of transport expense rules in a transport expense rule DB, determination of whether a retrieved route meets the transport expense rules, display of information regarding the retrieved route and a determined result, presentation of a suitable route candidate, and application of a transport expense meeting the transport expense rules”.

### SUMMARY OF THE INVENTION

According to Japanese Patent Application No. 2016-81101 (Publication No. JP2017-191494A), the travel route of the user is created from information regarding, for example, the entry station and the exit station recorded in the storage medium, such as an IC card. The transport expense application is allowed on the basis of the travel route. When the fare of the created route agrees with any one of the fares of the candidate routes included in the route search result, the transport expense application is approved. However, according to Japanese Patent Application No. 2016-81101, because the determination is based on only the fare of the route, no determination of whether the travel is the purpose of business is made.

JP 2014-49076 A describes automatic determination of whether the applied route agrees with the transport expense rules, with allowable means of transport registered in the transport expense rule DB. For approval of the transport expense application with the technique, first, destinations on business are previously registered in the transport expense rule DB. Then, collation of the application content with the destinations determines whether the transport expense application is necessary on business. However, in this case, because all destinations on business require previously registering, the load of addition or deletion of destinations is large.

Thus, an object of the present invention is to determine traveling necessary for the conduct of business and a destination, with the usage history of means of transport and location information, to automatically determine whether the traveling is usage for the purpose of business, from the usage history of the transport system.

In order to achieve the object, according to a representative aspect of the present invention, provided is a travel purpose determination method employing a travel purpose determination apparatus including a charging management device, a determination device, and a schedule management server in connection through a network, the travel purpose determination apparatus including a history acquisition unit, a schedule acquisition unit, a determination unit, and a determination rule database, the travel purpose determination method including: acquiring usage history including usage date and time indicating usage record of a transport system, location information, and user identification information, from the charging management device through the history acquisition unit; acquiring a schedule of a user from the schedule management server through the schedule acquisition unit, based on the user identification information and the usage date and time; and determining whether a purpose of travel is usage on business, from the usage history and the schedule of the user, through the determination unit, based on a determination rule stored in the determination rule database.

According to an embodiment of the present invention, determination of traveling necessary for the conduct of business and a destination, with the usage history of means of transport and location information, enables extraction of the traveling corresponding to usage for the purpose of business, from the usage history of the transport system. This arrangement enables a considerable reduction in the burden of travel management for a company or a user, so that billing/allowances to transport usage can be processed easier than ever before.

Objects, configurations, and effects other than the above will be clear in the descriptions of the following embodiments.

### BRIEF DESCRIPTION OF THE DRAWINGS

FIG. 1 is a diagram of a system configuration and functional blocks according to an embodiment of the present invention;

FIGS. 2A and 2B are tables of usage history and location information, respectively, according to the embodiment of the present invention;

FIGS. 3A and 3B are tables of schedule information according to the embodiment of the present invention;

FIG. 4 is a table of a usage statement according to the embodiment of the present invention;

FIGS. 5A and 5B are an illustration of a determination rule and a table of an approved destination list, respectively, according to the embodiment of the present invention;

FIGS. 6A to 6C are tables of an account and a contract plan according to the embodiment of the present invention;

FIG. 7 is a diagram of an exemplary system configuration according to the embodiment of the present invention;

FIG. 8 is an illustration of a user application screen according to the embodiment of the present invention;

FIG. 9 is a flowchart of the entirety of a determination flow according to the embodiment of the present invention;

FIG. 10 is a flowchart of the determination flow according to the embodiment of the present invention;

FIG. 11 is a flowchart of an addition flow of the approved destination list according to the embodiment of the present invention; and

FIG. 12 is a diagram of an exemplary system configuration according to another embodiment of the present invention.

### DESCRIPTION OF THE PREFERRED EMBODIMENTS

Embodiments of the present invention will be described below with reference to the drawings. Note that the present invention is not limited to the embodiments. For description of the drawings, the same constituents are denoted with the same reference signs.

### First Embodiment

[Configuration of Travel Purpose Determination System]

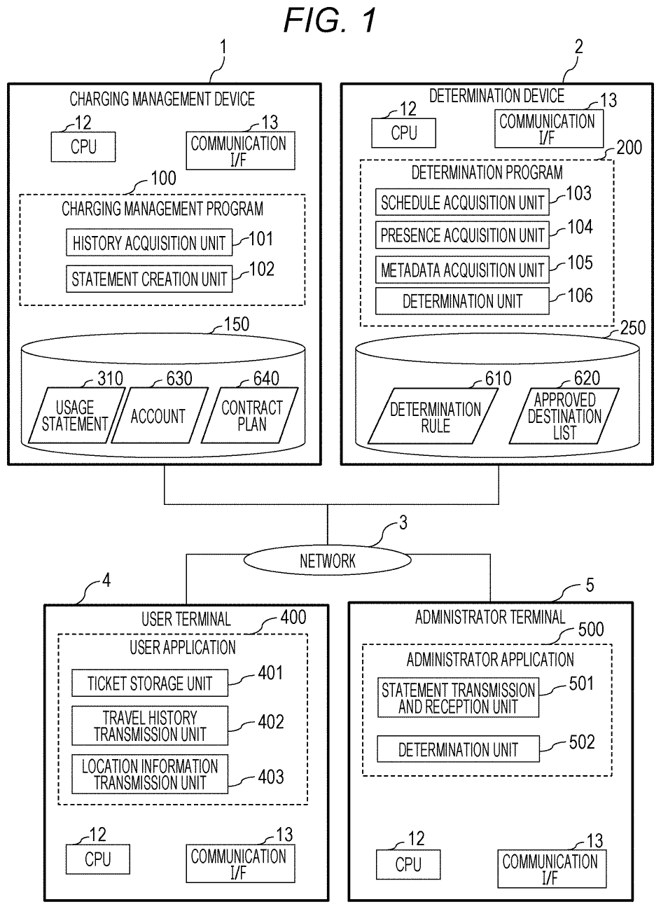

First, the configuration of hardware for achievement of an aspect of the present invention will be described with reference to FIG. 1.

FIG. 1 is a diagram of a system configuration and functional blocks according to an embodiment of the present invention. As illustrated in FIG. 1, the system configuration according to the present embodiment includes a charging management device 1, a determination device 2, a network 3, a user terminal 4, and an administrator terminal 5. The charging management device 1, the determination device 2, the user terminal 4, and the administrator terminal 5 are connected mutually communicably through the network 3.

The charging management device 1 includes a central processing unit (CPU) 12, a communication interface (hereinafter, also referred to as a “communication I/F”) 13, a charging management program 100, and a charging management database 150. The charging management database 150 stores a usage statement 310, an account 630, and a contract plan 640. The charging management program 100 includes a history acquisition unit 101 and a statement creation unit 102.

The determination device 2 includes a CPU 12, a communication I/F 13, a determination program 200, and a determination database 250. The determination database 250 stores a determination rule 610 and an approved destination list 620. The determination program 200 includes a schedule acquisition unit 103, a presence acquisition unit 104, a metadata acquisition unit 105, and a determination unit 106.

The user terminal 4 includes a CPU 12, a communication I/F 13, and a user application 400. The user application 400 includes: a ticket storage unit 401 that records an electronic ticket acquired from the charging management device 1; a travel history transmission unit 402 that stores the usage history of a transport system with the ticket and transmits the usage history to the charging management device 1; and a location information transmission unit 403 that transmits location information, such as latitude and longitude.

The administrator terminal 5 includes a CPU 12, a communication I/F 13, and an administrator application 500. The administrator application 500 includes: a statement transmission and reception unit 501 that transmits and receives data regarding the usage statement of the transport system, in cooperation with the determination program 200; and a determination unit 502 for an administrator to determine the usage purpose of the transport system in the usage statement.

Next, the respective operations of the constituent elements will be described in outline. First, the history acquisition unit 101 of the charging management program 100 in the charging management device 1 receives data of usage history and location information, from the user application 400 in the user terminal 4 through the communication I/F 13. Then, the statement creation unit 102 of the charging management program 100 creates a usage statement from the received usage history and location information, and stores the usage statement as the usage statement 310 into the charging management database 150.

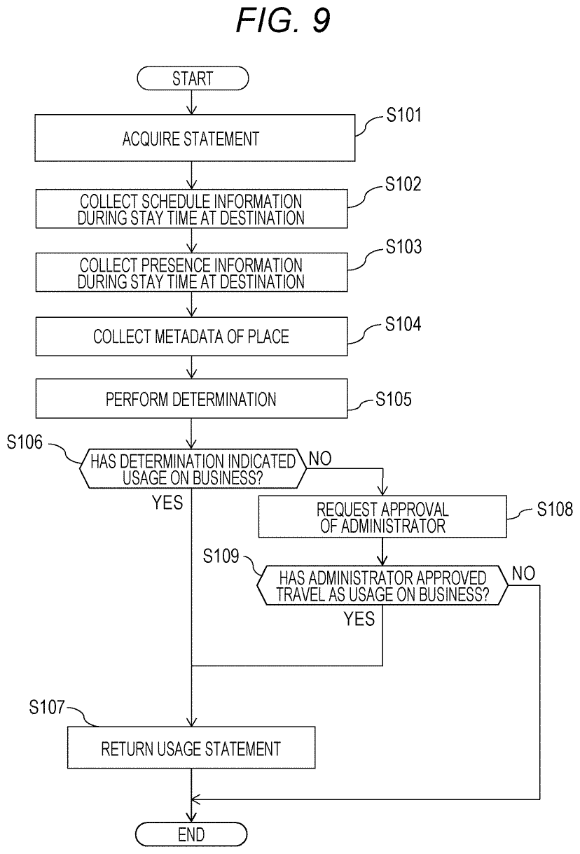

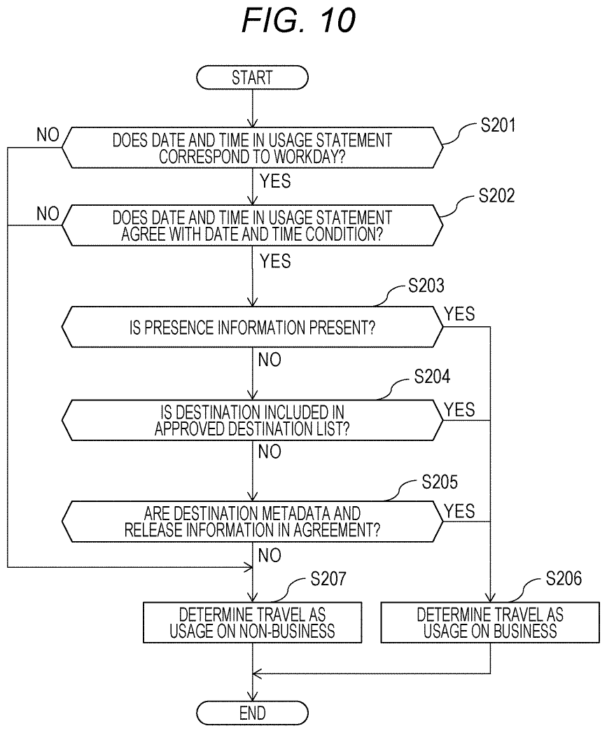

Next, the determination program 200 in the determination device 2 acquires the usage statement 310 from the charging management database 150 in the charging management device 1, and extracts the user ID identifying a user and the usage date and time from the usage statement 310. Then, the schedule acquisition unit 103 of the determination program 200 acquires schedule information regarding an employee having the user ID (namely, the user) at the usage date and time, from a schedule management serve (not exemplified in FIG. 1) managed by a company, through the communication I/F 13. Furthermore, the presence acquisition unit 104 of the determination program 200 acquires office access information regarding the employee having the user ID, at the usage date and time. Then, the determination unit 106 of the determination program 200 collates the acquired schedule information and the acquired office access information regarding the employee with the determination rule 610, to determine whether the statement is regarded as the purpose of business (the determination processing will be described later with reference to FIGS. 9 and 10).

Note that the aspect in which the data acquisition and the data determination are performed with the programs, has been described. However, the functions may be achieved by dedicated hardware or may be achieved by a module of software.

In a case where the usage statement 310 is determined as the purpose of business, the charging management program 100 in the charging management device 1 adds the usage for the transport system in the statement, to the account 630 of the company. The charging management program 100 determines a bill to the company, on the basis of the usage level of the transport system included in the account.

Next, the respective operations of the constituent elements in a case where the user uses the transport system, will be described in outline.

The user (e.g., an employee of the company) uses the transport system with the electronic ticket stored in the user application 400 that operates on the user terminal 4. Here, the electronic ticket presents the right of use of transport service to a terminal of a transport operator, such as a ticket gate, and saves the usage history of usage of transport service, therein, through means such as near field communication (NFC). After the usage of the transport system, the travel history transmission unit 402 of the user application 400 transmits the travel history to the charging management program 100 in the charging management device 1. Then, the charging management program 100 in the charging management device 1 acquires the travel history from the user terminal 4, creates a transport expense statement (e.g., the usage statement 310), and transmits the transport expense statement to the determination program 200 in the determination device 2. The travel history includes usage history and location information.

Next, the determination program 200 in the determination device 2 that has received the usage statement 310, acquires Global Positioning System (GPS) location information and a Bluetooth Low Energy (BLE) maker detected by the user application 400, from the usage statement 310, and further acquires office access information during a stay time at a travel destination (namely, presence information). Then, the determination program 200 determines the usage on business or the usage on non-business with collation with the determination rule 610. The detail of the determination rule 610 will be described later. For example, in a case where in-house office access information or in-house Wi-Fi connection information regarding the user has been acquired (namely, the stay of the user at a place regarded as being for business), the determination program 200 determines that the travel recorded in the usage statement 310 is the usage on business. In a case where the location information corresponds to location information previously registered in the approved destination list 620, the travel recorded in the usage statement 310 is determined as the usage on business. In this manner, according to the present embodiment, because of use of the access information regarding the user in determination processing, for example, even when the user travels, on a holiday, to a destination registered in the approved destination list 620, the travel is not determined as the purpose of business.

Next, in a case where the usage statement 310 is not determined as the usage on business, the determination program 200 transmits the usage statement 310 to the administrator application 500 in the administrator terminal 5. Then, the administrator determines the purpose of the usage statement 310 (namely, either the usage on business or the usage on non-business), and sends this determined result back to the determination program 200 in the determination device 2. Here, in a case where the administrator has approved the usage statement 310, the determination program 200 adds the destination recorded in the usage statement 310, to the approved destination list 620. After that, when a user belonging to the same organization (the same employee or a different employee) travels to the approved destination within a certain period, use of the approved destination list 620 enables the travel to be automatically regarded as the usage on business.

The processing causes separation of the usage history of the transport system into the travel necessary for the conduct of business and the rest travel, so that the company can be billed only for the expense of the travel necessary for the conduct of business.

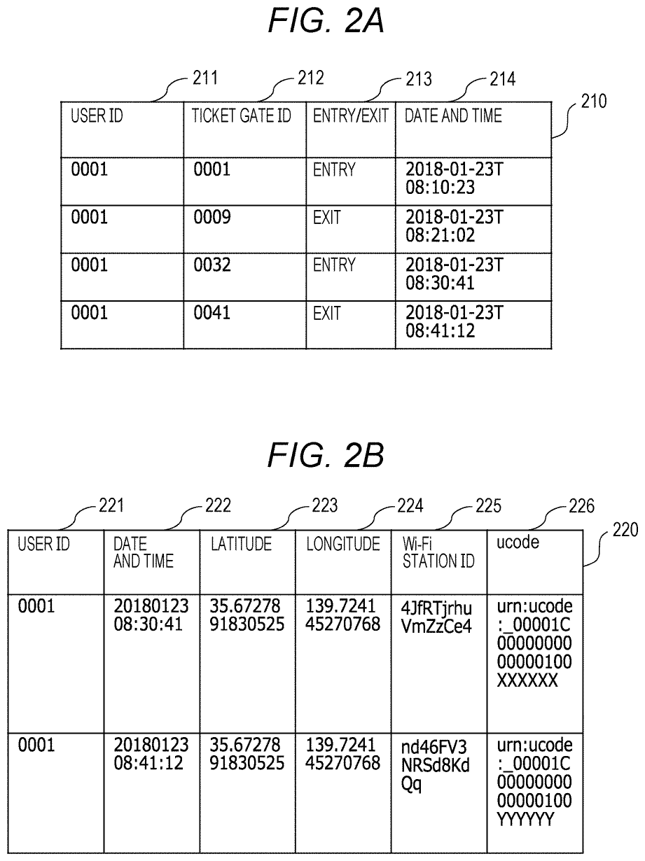

Next, information that the charging management device 1 and the determination device 2 store, will be described with reference to FIGS. 2 to 6.

FIGS. 2A and 2B illustrate usage history 210 and location information 220 created by the user application 400 in the user terminal 4 so as to be sent to the charging management device 1. As illustrated in FIG. 2A, the usage history 210 includes information regarding the travel of the user, such as user ID 211 indicating the identifier of the user, ticket gate ID 212 indicating the identifiers of ticket gates with the passage of the user, entry/exit 213 indicating entry or exit, and date and time 214 indicating the passage of the user.

As illustrated in FIG. 2B, the location information 220 includes: user ID 221 indicating the identifier of the user; date and time 222 indicating the date and time of observation of the location information; latitude 223 and longitude 224 indicating the latitude and the longitude of the place of stay of the user; Wi-Fi station ID 225 uniquely identifying the Wi-Fi station connected with the terminal of the user (e.g., a Wi-Fi station installed at a station or an airport); and ucode 226 uniquely identifying the place (e.g., a station, an office building, a shopping mall, or an event site).

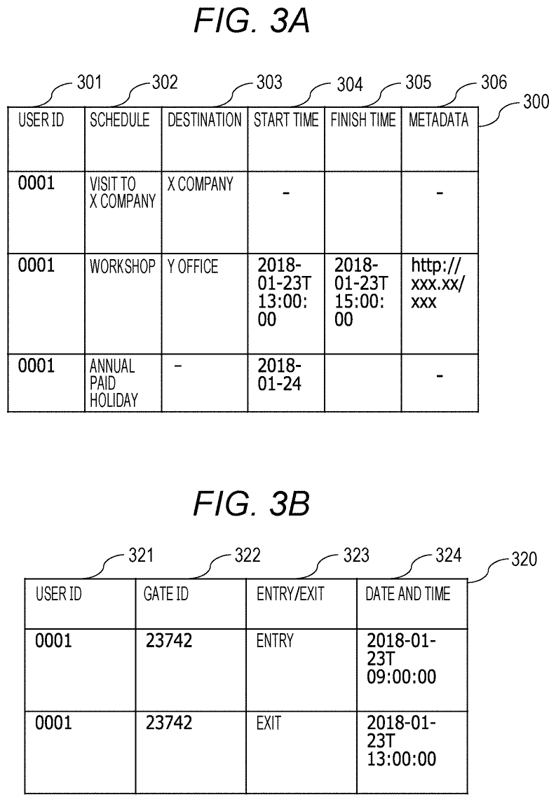

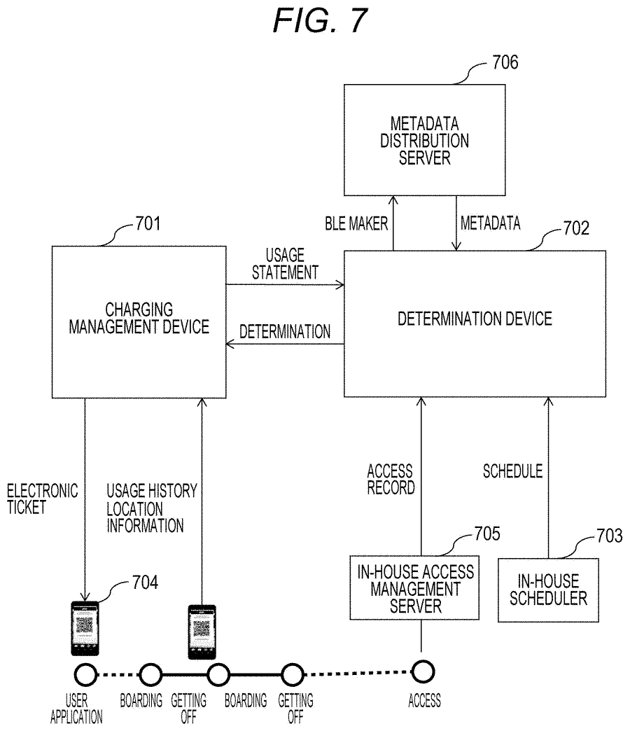

FIG. 3A is a table of schedule information 300 regarding the user that the schedule acquisition unit 103 of the determination program 200 acquires from the schedule management server managed by the company (e.g., an in-house scheduler 703 of FIG. 7 to be described later), according to the embodiment of the present invention. The schedule information 300 indicating the schedule or day's program of the user. For example, the schedule information 300 includes: the destination and the date and time for a business trip; and the day's program of a meeting. The schedule information 300 may be previously input in person through a computer or a terminal or may be input by a third party (e.g., an office worker belonging to the same company). As illustrated in FIG. 3A, the schedule information 300 includes: user ID 301 indicating the identifier of the user; schedule 302 indicating the schedule of the user; destination 303 indicating the destination of the schedule; start time 304 indicating the start time of the schedule; finish time 305 indicating the finish time of the schedule; and metadata 306 indicating supplementary information regarding the destination (e.g., the URL corresponding to the BLE maker).

FIG. 3B is a table of office access information 320 regarding the user that the presence acquisition unit 104 of the determination program 200 acquires. As illustrated in FIG. 3B, the office access information 320 includes: user ID 321 indicating the identifier of the user; gate ID 322 indicating the gate of an office accessed by the user; entry/exit 323 indicating entry or exit; and date and time 324 indicating the date and time of the passage through the gate. Note that the access information indicating the stay time of the user at a place, is also referred to as the presence information.

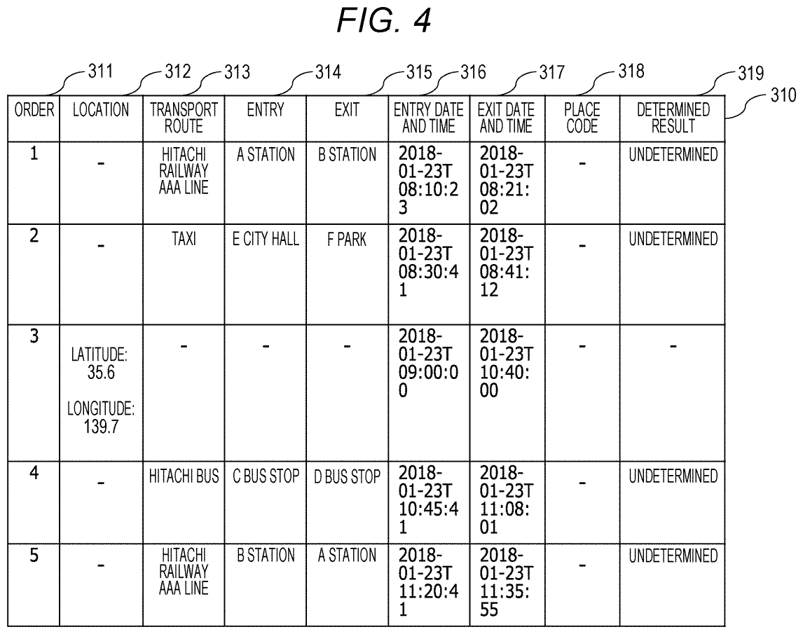

Next, a usage statement according to the embodiment of the present invention will be described with reference to FIG. 4. FIG. 4 is a table of the usage statement 310 created from the usage history 210 illustrated in FIG. 2A and the location information 220 illustrated in FIG. 2B by the statement creation unit 102 of the charging management program 100 according to the embodiment of the present invention. The usage statement 310 lists the usage history of the transport system of the user and the location information regarding the place accessed with the transport system, in chronological order.

The usage statement 310 includes: travel order 311 indicating the order of travel; location information 312 indicating the geographical coordinates of the place of stay of the user; transport route information 313 indicating the transport route used by the user; entry information 314 indicating the entry place of entry of the user into the transport route; exit information 315 indicating the exit place of exit of the user from the transport route; entry date and time 316 indicating the entry time of entry of the user into the transport route (e.g., the time of passage through the ticket gate of the entry station); exit date and time 317 indicating the exit time of exit of the user from the transport route; place code 318 indicating the place code uniquely identifying the travel destination, acquired at the travel destination (e.g., the URL corresponding to the ucode or the BLE maker); and determined result 319 indicating the determination status for the usage on business (e.g., the usage on business, the usage on non-business, or undetermined).

Note that, here, for the travel due to the usage of the transport system, no location information is present (e.g., orders 1, 2, 4, and 5). For the location information regarding the travel destination, no transport route information 313, no entry information 314 regarding the transport route, and no exit information 315 regarding the transport route are present (e.g., order 3).

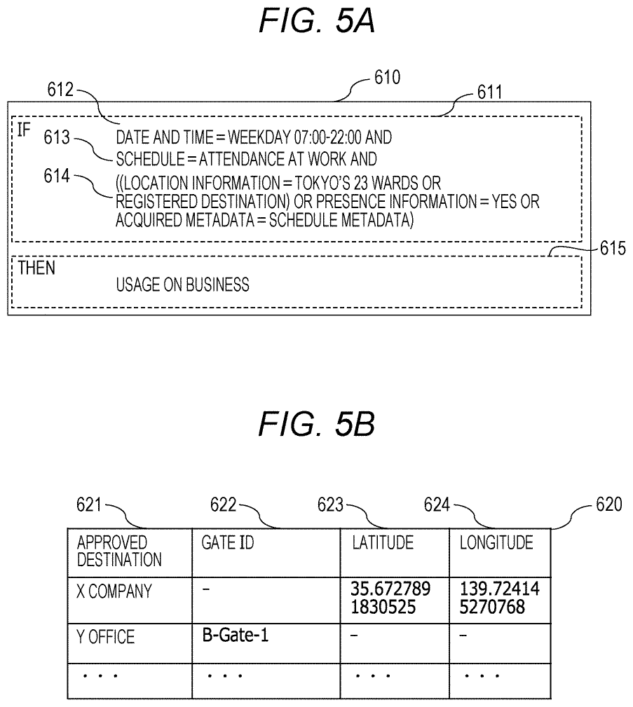

Next, a determination rule and an approved destination list according to the embodiment of the present invention, will be described with reference to FIGS. 5A and 5B. FIG. 5A illustrates an exemplary configuration of the determination rule 610 according to the present embodiment. The determination rule 610 that is a rule in IF-THEN form, includes: a condition section 611 for definition of a condition; and a conclusion section 615 for definition of a conclusion in a case where the condition defined in the condition section 611 is satisfied. Furthermore, the condition section 611 includes date and time condition 612, schedule condition 613, and location condition 614. In a case where the usage statement 310 corresponding to the travel of the user (namely, the usage history) satisfies the condition specified in the condition section 611 (a date and time condition, a schedule condition, and a location condition), the determination program 200 in the determination device 2 determines the travel as the purpose of business. Because the determination rule 610 includes the date and time condition, the schedule condition, and the location condition, the travel of the user under various situations (travel on a holiday or a workday, travel different from the previously input schedule, and travel deviating from the previously specified route) can be determined flexibly and accurately.

Next, a specific example of the determination rule 610 will be described. The date and time condition 612 specifying a specific period, such as “from Apr. 1, 2017 to Mar. 31, 2018” or a day and a period of time, such as “a weekday and from 7 to 22 o'clock”, is intended for verification of whether the date and time 214 in the usage history 210 agrees with the specification. The schedule condition 613 specifying a work schedule, is intended for verification of whether the schedule 302 in the schedule information 300 illustrated in FIG. 3A indicates attendance at work. The location condition 614 includes any one of a verification condition of whether the location information 220 illustrated in FIG. 2B is in a previously determined area, such as Tokyo's 23 wards, a verification condition of whether the location information 220 agrees with location information in the approved destination list 620, a verification condition of whether the presence information indicating access information regarding an in-house office or a contracted office is present (e.g., the stay time calculated from the entry date and time 316 and the exit date and time 317 of FIG. 4), and a verification condition of whether the metadata 306 of the schedule information 300 agrees with metadata acquired from a metadata distribution server 706 to be described later.

FIG. 5B is a table of an example of the approved destination list 620 that is part of the location condition 614 present in the determination rule 610 according to the embodiment of the present invention. The approved destination list 620 includes: name 621 indicating the name of an approved destination; gate ID 622 identifying the gate of the approved destination; and latitude 623 and longitude 624 indicating the latitude and the longitude of the approved destination, respectively. The approved destination list 620 lists places previously registered as the destination regarded as the usage on business. The determination program 200 in the determination device 2 determines the purpose of the travel in comparison between the destination of the user recorded in the usage statement 310 and the approved destination list 620, in determination processing to be described later.

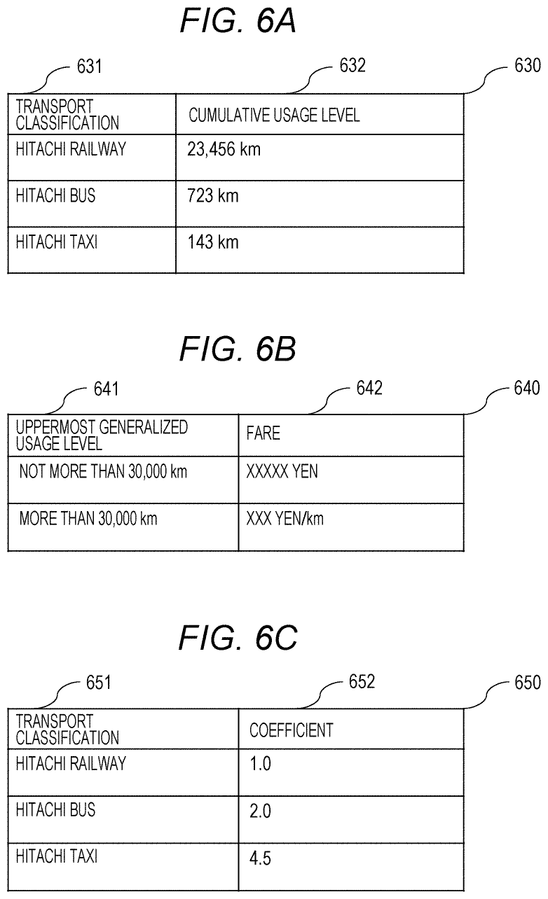

Next, an account and a contract plan according to the embodiment of the present invention, will be described with reference to FIGS. 6A to 6C. FIG. 6A is a table of the configuration of the account 630 stored in the charging management database 150 in the charging management device 1. The account 630 indicating a cumulative usage level every classification in the transport system according to the present embodiment, includes transport classification 631 and cumulative usage level 632. FIG. 6B is a table of the configuration of the contract plan 640 provided by a MaaS operator according to the present embodiment, stored in the charging management database 150. The contract plan 640 in which a fare is set for a generalized usage level that is the weighted sum of usage levels in the plurality of transport system, includes uppermost generalized usage level 641 and fare 642. FIG. 6C illustrates coefficient 650 for calculation of the generalized usage level, the coefficient 650 including transport classification 651 and coefficient 652. Multiplication of the coefficient 652 and the cumulative usage level of means of transport indicated in the transport classification 651 (e.g., the cumulative usage level 632) enables calculation of the fare 642 responsive to the cumulative usage level of the contract company.

Next, a system configuration according to the embodiment of the present invention, will be described with reference to FIG. 7. FIG. 7 is a diagram of the exchange of data between a charging management device 701, a determination device 702, the in-house scheduler 703, a user terminal 704, an in-house access management server 705, and the metadata distribution server 706, according to the embodiment of the present invention. Because the determination program 200 uses the schedule and the location information regarding the user who is an employee of the company, it is desirable that an outsider of the company is not allowed to refer thereto. Therefore, for that arrangement, as illustrated in FIG. 7, it is desirable that the charging management program 100 operates in the charging management device 701 of the MaaS operator and the determination program 200 operates in the determination device 702 of the client company. Note that the embodiment of the present invention is not limited to this, and thus the charging management program 100 and the determination program 200 may operate on the same calculator.

The charging management device 701 transmits an electronic ticket to the user application 400 operating in the terminal retained by the employee of the client company (e.g., the user terminal 4 of FIG. 1 or the user terminal 704 of FIG. 7), on the basis of the contract with the client company. Then, the charging management device 701 collects the usage history of the transport system with the ticket and the location information, from the user application 400, creates the usage statement 310, and transmits the user ID of the employee and the usage statement 310 to the determination device 702. Then, on the basis of the user ID and the date and time included in the usage statement 310, the determination device 702 acquires the schedule of the corresponding employee from the in-house scheduler 703 managing the schedules of employees, and acquires the access history regarding the corresponding employee (namely, the presence information) from the in-house access management server 705 managing the office access information regarding the employees.

The determination device 702 issues an inquiry with, as a key, the place code 318 included in the usage statement 310, to the external metadata distribution server, and acquires the metadata regarding the place. For example, the place code may be a ucode issued through Bluetooth (registered trademark) communication at an event site. Issuing an inquiry with the place code to the metadata distribution server 706, enables acquisition of location information, such as the latitude and the longitude of the place, information regarding an event, and the URL of the event.

Use of the system configuration illustrated in FIG. 7 enables cooperation between the service of the MaaS operator and the business management system of the contract company, resulting in a considerable reduction in the burden of travel management for the company or the user. Thus, billing/allowances to transport usage can be managed easier than ever before.

Note that, here, the aspect in which the usage history and the location information are acquired from the user application 400 operating in the user terminal that has received the electronic ticket from the charging management device 701, has been described, but the embodiment of the present invention is not limited to this. For example, an aspect in which the user terminal 704 has no user application 400, can be provided. In this case, a public transport company (not exemplified) used in traveling of the user, acquires the usage history of the user, and directly transmits the usage history of the user to the charging management device 701 (namely, data such as the usage history, is exchanged between the public transport company and the MaaS operator). This arrangement enables a further reduction in the burden of travel management for the contract company or the user.

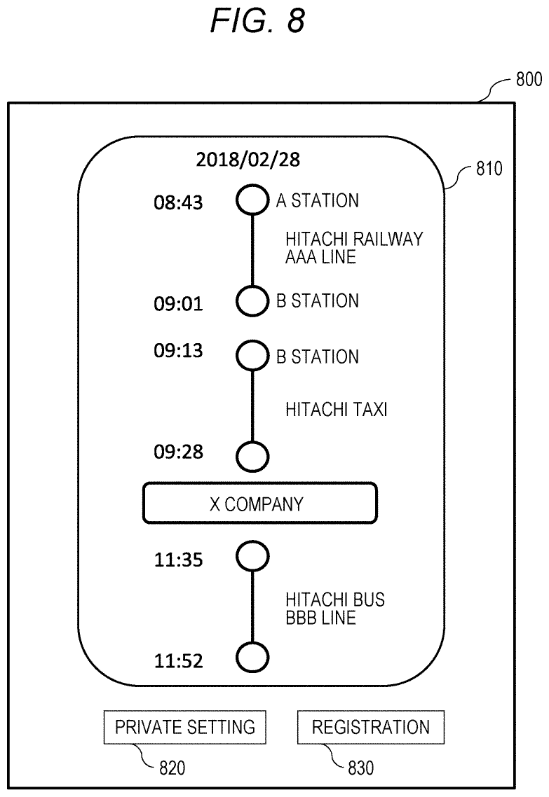

Next, a user application screen according to the embodiment of the present invention, will be described with reference to FIG. 8. FIG. 8 is an illustration of a usage history screen 800 of the user application 400 according to the embodiment of the present invention. The travel history screen 800 includes a graphical user interface (GUI) that allows the user of the user application 400 to verify the usage history 210 illustrated in FIG. 2A and the location information 220 illustrated in FIG. 2B. The user verifies the usage history 210 and the location information 220 displayed in a travel history display area 810 on the travel history screen 800, and presses a registration button 830, so that the user application 400 transmits the usage history 210 and the location information 220 to the charging management program 100. For this processing, the transmission may be performed manually by the user or the transmission may be performed automatically at the appointed time every day.

In a case where there is a stop-off site because of a private reason of the user, the user selects the corresponding stop-off site in the travel history display area 810 and presses a private setting button 820, so that the user application 400 can transmit the usage history 210 and the location information 220 from which information regarding the stop-off site is deleted.

Next, the entirety of a determination flow according to the embodiment of the present invention, will be described with reference to FIG. 9. FIG. 9 is a flowchart of determination processing in the determination unit 106 of the determination program 200 to be executed by the determination device 2, in outline. First, the schedule acquisition unit 103 of the determination program 200 acquires the usage statement 310 that is undetermined, from the charging management database 150 in the charging management device 1. Then, the schedule acquisition unit 103 extracts the user ID and the usage date and time from each usage statement (S101). The schedule acquisition unit 103 specifies the stay time at the destination from the usage date and time, and acquires the schedule information corresponding to the stay time (S102). Next, the presence acquisition unit 104 acquires the presence information regarding the stay time (S103).

Subsequently, the metadata acquisition unit 105 issues a search request with, as a key, the place code 318 acquired at the stay time, to the metadata distribution server, and acquires the place of the destination and the URL of the event as the metadata (S104). Then, the determination unit 106 collates the information with the determination rule 610, to determine whether the travel in the usage statement is the purpose of business (S105). The determination processing will be described later with reference to FIG. 10. Here, in a case where a result of the determination indicates the usage on business, the determination unit 106 adds an approved flag to the statement (S107). In a case where a result of the determination indicates the usage on non-business at S106, for example, the determination program 200 sends the usage statement to the administrator application 500 in the administrator terminal 5 (S108). Then, in a case where the administrator using the administrator application 500 approves the travel recorded in the usage statement as the usage on business, an approved flag is added to the statement (S107).

Next, the detail of the determination flow according to the embodiment of the present invention, will be described with reference to FIG. 10. FIG. 10 is a flowchart of the detail of the determination processing in the determination unit 106. First, the determination unit 106 of the determination program 200 operating in the determination device 2 verifies whether the date and time of the usage statement being processed (e.g., the entry date and time 316 and the exit date and time 317 indicated in the usage statement 310 of FIG. 4) corresponds to the workday in the acquired schedule information (e.g., the schedule information 300 of FIG. 3A) (S201). In a case where the date and time of the usage statement is specified as the holiday in the acquired schedule information, the travel recorded in the usage statement is determined as the usage on non-business (S207). Next, the determination unit 106 verifies whether the date and time of the usage statement being processed agrees with the date and time condition in the determination rule 610 (S202). In a case where the date and time of the usage statement disagrees with the date and time condition in the determination rule 610, the travel recorded in the usage statement is determined as the usage on non-business (S207).

Subsequently, the presence acquisition unit 104 of the determination program 200 acquires the presence information during the stay time at the destination in the usage statement, from the access management server of the company (e.g., the in-house access management server 705 of FIG. 7) (S203). In a case where the presence information corresponds to the place and the period of time specified in the determination rule 610 is present, the travel recorded in the usage statement is determined as the purpose of business (S206). In a case where no presence information corresponding to the place and the period of time specified in the determination rule 610 is present at S203, when the location information in the usage statement (e.g., the location information 312 illustrated in FIG. 4) agrees with the location information in the approved destination list (e.g., the approved destination list 620 illustrated in FIG. 5B) (S204), the travel recorded in the usage statement is determined as the purpose of business (S206).

In a case where the location information in the usage statement disagrees with the location information in the approved destination list at S204, the determination unit 106 compares the URL of the destination metadata included in the schedule information, to the URL acquired with, as a key, the place code of the destination from the metadata distribution server (e.g., the metadata distribution server 706 illustrated in FIG. 7). In a case where the URL of the destination metadata included in the schedule information and the URL acquired from the metadata distribution server are in agreement (S205), the travel recorded in the usage statement is determined as the purpose of business (S206). For disagreement, the travel recorded in the usage statement is determined as the purpose of non-business (S207).

Note that the Wi-Fi station ID 225 illustrated in FIG. 2B may be used in the present determination processing. For example, in a case where information regarding the Wi-Fi station ID 225 is present, the determination unit 106 determines whether the Wi-Fi station ID 225 agrees with the in-house Wi-Fi station ID or the destination-list Wi-Fi station ID registered in the approved destination list. In a case where the Wi-Fi station ID 225 of the Wi-Fi station in connection with the user terminal 4 agrees with the in-house Wi-Fi station ID or the Wi-Fi station ID of the approved destination list, the travel recorded in the usage statement is determined as the purpose of business. For disagreement, the travel recorded in the usage statement is determined as the purpose of non-business.

The determination processing in this manner results in a considerable reduction in the burden of travel management for the company or the user. Thus, billing/allowances to transport usage can be managed easier than ever before.

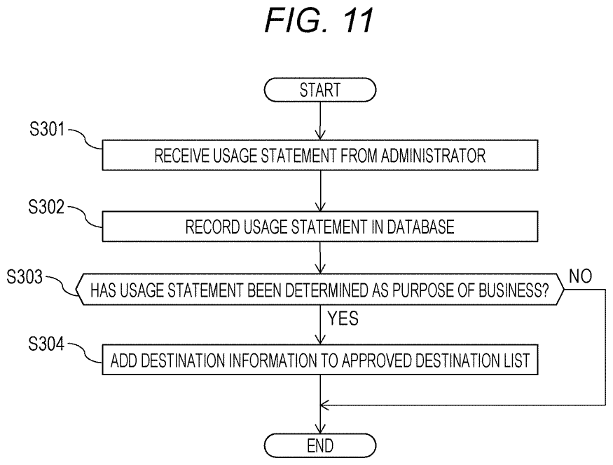

Next, an addition flow of the approved destination list according to the embodiment of the present invention, will be described with reference to FIG. 11. FIG. 11 is a flowchart of addition processing of the approved destination list, based on a determined result of the determination unit 106. The determination unit 106 of the determination program 200 receives the usage statement returned from the administrator application 500 (e.g., the usage statement returned at S107 illustrated in FIG. 9) (S301), and records the usage statement in the determination database 250 in the determination device 2 (S302). Here, it is verified whether the administrator has determined the usage statement as the purpose of business (S303). In a case where the travel recorded in the usage statement has been determined as the purpose of business, the determination program 200 adds the destination information in the usage statement to the approved destination list 620 (S304).

According to the present embodiment, the determination program 200 records the destination determined as the purpose of business by the administrator and the location corresponding to the destination, for use as the approved destination. With this arrangement, in a case where the user specifies this destination as the destination in a usage statement, because this destination has been once approved, this destination can be determined as the purpose of business.

### Second Embodiment

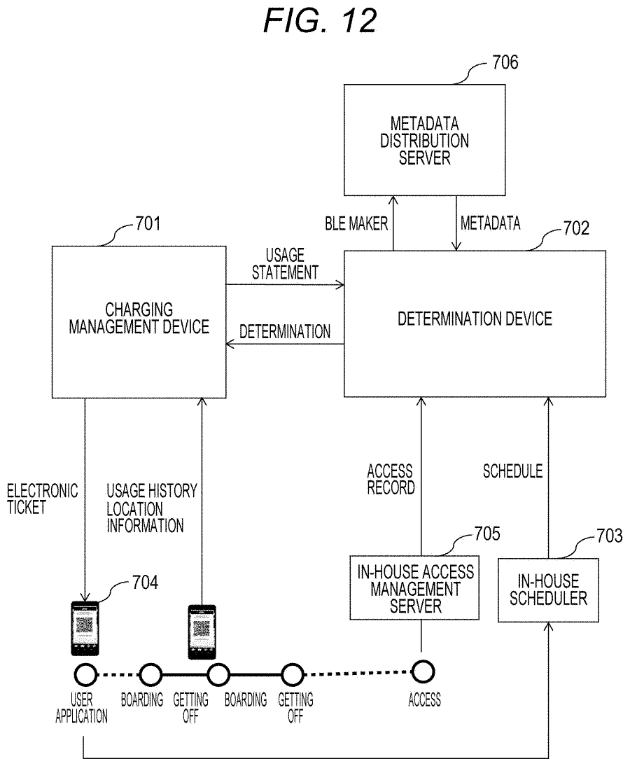

Next, a second embodiment of the present invention will be described with reference to FIG. 12. According to the first embodiment, the schedule management server (e.g., the in-house scheduler 703 of FIG. 7) stores the schedule information regarding the user (e.g., the schedule information 300 illustrated in FIG. 3A) that is previously input, in a format invariable to the user. However, according to the second embodiment, schedule information stored in a schedule management server may be updated in real time by a remote operation of a user. With this arrangement, in a case where the schedule of the user is changed, the user updates the schedule information stored in the schedule management server, resulting in an effect that travel purpose determination accuracy improves.

Note that, the second embodiment is similar to the first embodiment except for real-time update of the schedule information stored in the schedule management server by a remote operation of the user, and thus the descriptions of the elements above will be omitted here.

Specifically, as illustrated in FIG. 12, a user terminal 704 is directly communicably connected to an in-house scheduler 703. Due to an input from the user, a user application operating in the user terminal 704 transmits a schedule update request including the user ID identifying the user and an update instruction specifying how to update the schedule, to the in-house scheduler 703. The in-house scheduler 703 that has received the schedule update request, reads the schedule information corresponding to the user, with the user ID. On the basis of the update instruction in the schedule update request, the in-house scheduler 703 updates the schedule information regarding the user, and saves the updated schedule information.

Note that the in-house scheduler 703 may add a flag of “unverified” to the updated schedule information, and may transmit the notification to an administrator application (e.g., the administrator application 500 operating in the administrator terminal 5 of FIG. 1). In a case where the administrator approves the schedule information regarding the user, the updated schedule information may be used in the travel purpose determination processing. Meanwhile, in a case where the administrator disapproves the schedule information regarding the user, the schedule information before the update is used in the travel purpose determination processing.

In this manner, the schedule information regarding the user stored in the in-house scheduler 703 can be updated in real time by a remote operation of the user. Thus, determination error can be inhibited in the determination processing, so that the travel purpose of the user can be determined more accurately. For example, generally, in a case where the route of travel or the date and time deviates from the schedule previously input in the in-house scheduler 703, by reason of a meeting person or a transport system, the travel of the user being out is likely to be determined as the purpose of non-business.

Note that, as described in the present embodiment, even when the user is being out, use of the user application enables real-time update of the schedule information regarding the user stored in the in-house scheduler 703, based on the change of the route of travel or the date and time. Thus, the latest schedule information can be used in the travel purpose determination processing, resulting in an effect that the travel purpose determination accuracy improves.

The embodiments of the present invention have been described above, but are just exemplary for description of the present invention. Thus, the scope of the present invention is not limited to the embodiments. Various modes may be made for the present invention.

What is claimed is:

1. A travel purpose determination method with a travel purpose determination apparatus including a charging management device, a determination device, and a schedule management server in connection through a network,
the travel purpose determination apparatus including a history acquisition unit, a schedule acquisition unit, a determination unit, and a determination rule database, the travel purpose determination method comprising:
acquiring usage history including usage date and time indicating usage record of a transport system, location information, and user identification information, from the charging management device through the history acquisition unit;
acquiring a schedule of a user from the schedule management server through the schedule acquisition unit, based on the user identification information and the usage date and time; and
determining whether a purpose of travel is usage on business, from the usage history and the schedule of the user, through the determination unit, based on a determination rule stored in the determination rule database.

2. The travel purpose determination method according to claim 1, wherein
the determination rule includes a condition section including:
a date and time condition specifying a date, a day, a period of time, or a period regarded as the usage on business;
a schedule condition specifying schedule information regarded as the usage on business; and
a location condition specifying location information, access information, or connection information regarded as the usage on business.

3. The travel purpose determination method according to claim 2, wherein
the determining includes:
comparing the usage history and the schedule of the user to the condition section of the determination rule;
determining,
in a case where the schedule of the user satisfies the schedule condition in the condition section and
the usage history satisfies the date and time condition and the location condition in the condition section,
the usage history as a purpose of business; and
determining,
in a case where the schedule of the user does not satisfy the schedule condition in the condition section, or
in a case where the usage history does not satisfy the date and time condition or the location condition in the condition section, the usage history as a purpose of non-business.

4. The travel purpose determination method according to claim 1, wherein
the determination rule includes an approved destination list including destination name and destination location information, and
the determining includes:
comparing the location information in the usage history to the destination location information in the approved destination list; and
determining, in a case where the location information agrees with at least one piece of the destination location information, the usage history as a purpose of business.

5. The travel purpose determination method according to claim 3, wherein
in a case where the usage history has been determined as the purpose of non-business,
the determining further includes:
transmitting the usage history to an administrator application used by an administrator;
receiving a determined result including a new destination and new location information determined as the purpose of business by the administrator; and
adding the new destination and the new location information to an approved destination list.

6. A travel purpose determination apparatus connected to a charging management device and a schedule management server through a network,
the travel purpose determination apparatus comprising:
a history acquisition unit configured to acquire usage history including usage date and time indicating usage record of a transport system, location information, and user identification information, from the charging management device;
a schedule acquisition unit configured to acquire a schedule of a user from the schedule management server, based on the user identification information and the usage date and time in the usage history;
a determination rule database storing a determination rule; and
a determination unit configured to determine whether a purpose of travel is usage on business, from the usage history and the schedule of the user, based on the determination rule stored in the determination rule database.

7. The travel purpose determination apparatus according to claim 6, wherein
the determination rule includes a condition section including:
a date and time condition specifying a date, a day, a period of time, or a period regarded as the usage on business;
a schedule condition specifying schedule information regarded as the usage on business; and
a location condition specifying location information, access information, or connection information regarded as the usage on business.

8. The travel purpose determination apparatus according to claim 7, wherein
the determination unit:
compares the usage history and the schedule of the user to the condition section of the determination rule;
determines,
in a case where the schedule of the user satisfies the schedule condition in the condition section and
the usage history satisfies the date and time condition and the location condition in the condition section,
the usage history as a purpose of business; and
determines,
in a case where the schedule of the user does not satisfy the schedule condition in the condition section or
in a case where the usage history does not satisfy the date and time condition or the location condition in the condition section,
the usage history as a purpose of non-business.

9. The travel purpose determination apparatus according to claim 6, wherein
the determination rule includes an approved destination list including destination name and destination location information, and
the determination unit:
compares the location information in the usage history to the destination location information in the approved destination list; and
determines, in a case where the location information agrees with at least one piece of the destination location information, the usage history as a purpose of business.

10. The travel purpose determination apparatus according to claim 8, wherein
in a case where the usage history has been determined as the purpose of non-business,
the determination unit:
transmits the usage history to an administrator application used by an administrator;
receives a determined result including a new destination and new location information determined as the purpose of business by the administrator; and
adds the new destination and the new location information to an approved destination list.

11. A travel purpose determination system comprising: a user terminal; a charging management device; a determination device; a schedule management server; and a network connecting the user terminal, the charging management device, the determination device, and the schedule management server, wherein
the determination device includes a determination unit and a determination rule database,
the charging management device
acquires usage history including usage date and time indicating usage record of a transport system, location information, user identification information, from the user terminal, and transmits the usage history to the determination device, and
the determination device
receives the usage history from the charging management device,
acquires a schedule of a user from the schedule management server, based on the user identification information and the usage date and time in the usage history, and
determines, through the determination unit, whether a purpose of travel is usage on business, from the usage history and the schedule of the user, based on a determination rule stored in the determination rule database.

12. The travel purpose determination system according to claim 11, wherein
the determination rule includes a condition section including:
a date and time condition specifying a date, a day, a period of time, or a period regarded as the usage on business;
a schedule condition specifying schedule information regarded as the usage on business; and
a location condition specifying location information, access information, or connection information regarded as the usage on business.

13. The travel purpose determination system according to claim 12, wherein
the determination device:
compares the usage history and the schedule of the user to the condition section of the determination rule;
determines,
in a case where the schedule of the user satisfies the schedule condition in the condition section
and the usage history satisfies the date and time condition and the location condition in the condition section,
the usage history as a purpose of business; and
determines,
in a case where the schedule of the user does not satisfy the schedule condition in the condition section or
in a case where the usage history does not satisfy the date and time condition or the location condition in the condition section, the usage history as a purpose of non-business.

14. The travel purpose determination system according to claim 11, wherein
the determination rule includes an approved destination list including destination name and destination location information, and the determination device:
compares the location information in the usage history to the destination location information in the approved destination list; and
determines, in a case where the location information agrees with at least one piece of the destination location information, the usage history as a purpose of business.

15. The travel purpose determination system according to claim 11, comprising: the user terminal; an administrator terminal; the charging management device; the determination device; the schedule management server; and a network connecting the user terminal, the administrator terminal, the charging management device, the determination device, and the schedule management server, wherein
the determination device includes a determination unit and a determination rule database storing a determination rule including a condition section including:
a date and time condition specifying a date, a day, a period of time, or a period regarded as usage on business;
a schedule condition specifying schedule information regarded as the usage on business; and
a location condition specifying location information, access information, or connection information regarded as the usage on business,
the charging management device
acquires the usage history including the usage date and time indicating usage record of a transport system, the location information, and the user identification information,
creates a usage statement, based on the usage history, and transmits the usage statement to the determination device,
the determination device
receives the usage statement from the charging management device, and
acquires a schedule of the user from the schedule management server, based on the user identification information and the usage date and time in the usage statement, and
the determination unit:
compares the usage statement and the schedule of the user to the condition section of the determination rule;
determines,
in a case where the schedule of the user satisfies the schedule condition in the condition section and
the usage statement satisfies the date and time condition and the location condition in the condition section,
the usage statement as a purpose of business; and
determines,
in a case where the schedule of the user does not satisfy the schedule condition in the schedule section or
in a case where the usage statement does not satisfy the date and time condition or the location condition in the condition section, the usage statement as a purpose of non-business.
